(19) United States
(12) Patent Application Publication
(10) Pub. No.: US 2009/0155439 A1
(43) Pub. Date: Jun. 18, 2009

(54) Mechanical extrusion process for stabilizing cereal and oil seed bran and germ components

(76) Inventors: Leo Gingras, Scottsdale, AZ (US); Paul Mathewson, Scottsdale, AZ (US); Stephen Holloman, Woodland, CA (US); Rani Madhavapeddi Patel, Phoenix, AZ (US)

Correspondence Address: MCDERMOTT, WILL & EMERY LLP;Attn: IP Department, 227 WEST MONROE STREET, SUITE 4400, CHICAGO, IL, 60606-5096, US

(21) Appl. No.: 12/316,312

(22) Filed: Dec. 11, 2008

Related U.S. Application Data
(60) Provisional application No. 61/013,960, filed on Dec. 14, 2007.

(51) Int. Cl. A23L 1/10

(52) U.S. Cl. 426/507; 426/618

(57) ABSTRACT

The present invention provides a mechanical extrusion stabilization process for whole grains having a shelf life of at least 12 months. Whole grain food compositions using the stabilized bran of the present invention, and blended compositions are also described.

### CROSS-REFERENCE TO RELATED APPLICATIONS

This application claims priority to U.S. Provisional Application No. 61/013,960, filed Dec. 14, 2007, which is hereby incorporated by reference.

### FEDERALLY SPONSORED RESEARCH OR DEVELOPMENT

Not Applicable.

### TECHNICAL FIELD

This invention relates to a method for stabilizing whole grain components using a mechanical extrusion method, wherein the stabilized grain components have a shelf life of at least 12 months. The present invention also relates to compositions comprising extruded grain products.

### BACKGROUND OF THE INVENTION

Whole grains are known for their nutrition and health benefits and have been considered a staple food for humans for over 4000 years. While whole grains are quite stable, processed components of whole grains such as bran and germ fractions may have a relatively short shelf-life, as they can be subjected to a number of degradative processes including enzymatic degradation, microbial growth and insect infestation, all of which contribute to diminution in functional characteristics including nutritional content, organoleptic properties and product acceptability. The inability of the food industry to control these degradative factors has led to more refined grain products and less whole grain food stuffs. Researchers, however, continue to identify significant health benefits associated with eating whole grains and consumers are now demanding more whole grain products. Thus, there is an impetus for the food industry to include whole grains in a variety of food products such as breads, snacks, nutritional bars, breakfast cereals and others.

There is increasing evidence that whole grains, particularly the bran fractions, contain phytochemicals that, when included in a daily diet, provide long term health benefits and decrease the risk of chronic diseases such as obesity (McMillan-Price and Brand-Miller 2006, Arch. Intern. Med. 166: 1466-1475; Koh Bannerjee et al. 2004, Am. J. Clin. Nutr. 80: 1237-1245) and diabetes (Fung et al. 2002, Am. J. Clin. Nutr. 76: 535-540; Liese et al. 2003, Am. J. Clin. Nutr. 78: 965-971; Montonen et al. 2003, Am. J. Clin. Nutr. 77: 622-629) by regulating glucose levels and insulin production (see, McIntosh et al. 2003, Am. J. Clin. Nutr. 77: 967-974; Periera et al. 2002, Am. J. Clin. Nutr. 75: 848-855). The bran fraction is also reported to lower the blood pressure (Behall et al. 2004, Am. J. Clin. Nutr. 50: 1185-1193) and cholesterol (Behall et al. 2004, J. Am. Coll. Nutr. 23: 55-62; Davy et al. 2002, Am. J. Clin. Nutr. 76: 351-358; Davy et al 2002, J. Nutr. 132: 394-398), and reduce the progression of coronary atherosclerosis (Kahlon et al. 1992, J. Nutr. 122: 513-519) and cancer (Zoran et al. 1997 J. Nutr. 127: 2217-2225). Both the Department of Health and Human Services and the FDA support increasing whole grain intake in the US to reduce the risk of chronic diseases (DHHS 2000, FDA 1999, FDA 2003, DHHS 2005). Larger scale use of whole grain components requires that those components, the bran and the germ in particular, be sufficiently stabilized to prevent or significantly retard the degradative changes that currently limit their use.

In addition, the nutraceutical value of stabilized rice bran in treatment of a number of human ailments, such as diabetes, coronary diseases, arthritis, and cancer, have been described in the following commonly-owned U.S. patents and patent application Publication including: U.S. Pat. No. 5,985,344, entitled, “Process for Obtaining Micronutrient Enriched Rice Bran Oil;” U.S. Pat. No. 6,126,943 entitled, “Method for Treating Hypercholesterolemia, Hyperlipidemia, and Atherosclerosis;” U.S. Pat. No. 6,303,586 entitled, “Supportive Therapy for Diabetes, Hyperglycemia and Hypoglycemia;” U.S. Pat. No. 6,558,714, entitled “Method for Treating Hypercholesterolemia, Hyperlipidemia, and Atherosclerosis;” U.S. Pat. No. 6,733,799 entitled “Method for Treating Hypercholesterolemia, Hyperlipidemia, and Atherosclerosis;” U.S. Pat. No. 6,902,739, entitled “Method for treating Joint Inflammation, Pain, and Loss of Mobility;” and U.S. Patent Application Publication US 2008/0038385 entitled “Therapeutic uses of an anti-cancer composition derived from rice bran.” These patents are hereby incorporated by reference in their entireties.

The first step in the process of milling grains consists of removing the outer layer, whether hull or pericarp from the whole harvested grain. Further processing results in fractions rich in starchy endosperm and those comprised of bran and germ material. It is the bran/germ fraction that is most problematic in terms of functional and organoleptic stability because this fraction tends to have a higher lipid content along with significant lipolytic and or oxidative enzyme activities. The milling process releases these enzymes, which can hydrolyze/oxidize the lipids associated with bran and germ fractions, leading to generation of compounds that contribute to the undesirable taste and odors characteristic of rancidity. Formation of these compounds can be quite rapid and their presence in food products represents a significant barrier to widespread inclusion of bran/germ fraction in food formulations. Thus, use of the bran and germ components known to provide many healthful attributes to the food supply requires stabilization of the bran/germ fraction. This stabilization process requires inactivation of the lipolytic enzymes in the bran/germ fraction.

Several methods have been developed to stabilize the germ and bran components of whole grain including application of direct heat and/or steam and cold treatments such as refrigeration and/or freezing. Pan roasting and microwave roasting techniques have been developed, which can stabilize bran for up to 3 months (Ahmed et al. J. Sci. Food Agri. 87: 60-67). Cold treatments are generally considered to be poor choices due to expense and because the approach is logistically problematic. Bran fractions can also be stabilized by extracting the oil to produce defatted bran (DFB). Methods of inactivating lipolytic enzymes by application of chemicals, such as hydrochloric acid, acetic acid, acrylonitrile, and propanal have also been used (Prakash & Ramanathan 1995, J. Food Sci. Tech. 32:395-399). Attempts have also been made to inactivate these enzymes utilizing both dry and wet methods of heating (Sayre et al 1982, Cereal Foods World 27: 317).

Commercial systems for stabilizing bran and germ components typically utilize moisture-added or dry extrusion methods. These systems are selected because of their relatively low energy requirements, low capital costs and ease of operation. Stabilization by dry extrusion utilizes shear, friction, and pressure to generate the heat required to inactivate the lipolytic/oxidative enzymes.

The inactivation temperature for lipid-degrading enzymes decreases with increasing moisture content so a wet heat extrusion process is usually more effective than dry heat extrusion. Wet heat also helps to sterilize the product, kills insect larvae and results in a more effective inactivation of lipid-degrading enzymes. The stabilization of whole grain components using current wet and dry extrusion processes is effective for about three months. Many food products require a significantly longer period of hydrolytic/oxidative stability in order to fit consumer expectations and the food distribution system. Thus, a more effective stabilization process, providing significantly longer shelf-life of a whole grain product would be of value in the food industry. A process in which the long-term hydrolytic/oxidative stability could be achieved while maintaining the integrity of other valuable micronutrients (phytochemicals, antioxidants etc.) would be especially valuable.

Besides cereal milling, the milling of oil seeds also produces a significant amount of bran material. At present, the bran fraction obtained in oil seed milling industry is discarded as a waste. A suitable procedure to stabilize the bran material resulting from oil seed milling would provide additional ingredients both for food and feed industries.

In view of the above, there remains a need in the art for effective methods of stabilizing whole grain components, especially the bran and germ portions, to prevent rancidity and reduce microbial and insect loads for at least 12 months. Generally, it is desirable that proteins are not denatured during the stabilization process. In addition, it is also equally important to make sure that the antioxidants, vitamins and other phytochemicals are not significantly diminished during the stabilization procedure. Such a stabilized bran/germ fraction would afford the food industry access to nutritious, healthful whole grain products. The present invention satisfies these and other needs.

### SUMMARY OF THE INVENTION

In one aspect, the present invention provides a method for stabilizing whole grain components, the bran and germ portions in particular, by a mechanical extrusion process that results in the production of stabilized bran and germ fractions having a shelf-life of at least 12 months or more. The method includes the steps of loading the raw bran material into a mechanical extruder, applying power, heat and pressure at suitable levels for enzyme denaturation, maintaining the bran material in the extruder at a residence time suitable for stabilization, adding water to maintain a level of moisture content in a stabilized bran material, and testing free fatty acid levels in the stabilized bran material.

The extrusion stabilization process of the present invention utilizes specially designed extrusion technology that results in rapid, even generation of heat creating a small temperature gradient across the bran/germ mass.

In another embodiment, this invention inactivates the lipase and peroxidase enzymes and provides a stabilized bran fraction with no detectable lipase and peroxidase enzyme activities.

In yet another embodiment, this invention provides a stabilized bran/germ fraction with a free fatty acid (FFA) content of 5% or lower during at least twelve months of storage.

In another embodiment, the invention provides a stabilized bran preparation which maintains level of tocopherol and tocotrienol substantially unchanged during the course of at least twelve months.

In another aspect, the present invention provides for food blend compositions comprising various blends of whole grain components including stabilized bran/germ fraction produced by the inventive mechanical extrusion process. Such whole grain compositions have an improved shelf-life and/or the nutritional profile as compared to similar whole grain compositions prepared with bran/germ fraction not subjected to stabilization through mechanical extrusion procedure. The stabilized bran preparation of the present invention can also be used as a feed additive.

These and other aspects will become more apparent when read with the accompanying detailed description and figures which follow.

### BRIEF DESCRIPTION OF THE DRAWINGS

FIG. 1 illustrates the development of FFA content during 12 months of storage in raw rice bran and in the rice bran/germ fraction stabilized by the inventive process.

FIG. 2 illustrates tocotrienol stability in the stabilized rice bran/germ fraction after 12 months of storage. Shown in the figure are the content of three different forms of tocotrienols in the rice bran/germ fraction stabilized by the inventive process as compared to the content in the fresh raw rice bran/germ fraction obtained immediately after rice milling operation.

FIG. 3 illustrates tocopherol stability in the stabilized rice bran/germ fraction after 12 months of storage. Shown in the figure are the content of two different forms of tocopherols in the rice bran/germ fraction stabilized by the inventive process as compared to the content in the fresh raw rice bran/germ fraction obtained immediately after rice milling operation.

### DETAILED DESCRIPTION

The present invention provides a method for stabilizing bran/germ fractions obtained from various cereal grains, comprising mechanically extruding the bran/germ fraction to form a stabilized bran/germ fraction wherein the stabilized bran/germ fraction has an increased shelf-life of at least 12 months. This extrusion stabilization process is also suitable for stabilizing the bran materials resulting from the oil seed milling industry.

Cereal grains include certain active degradative enzymes such as peroxidase and lipases that can produce spoilage of food products prepared from the whole grain, such as a flour or dough. Anatomically, a cereal grain includes three major portions namely the endosperm, the germ, and the bran. The major portion of a cereal grain is made up of starchy endosperm. For example, in the case of wheat kernel, the endosperm accounts for about 80% weight percent while the bran/germ portion makes up approximately 20% weight percent of the grain.

The degradative enzymes are significantly more concentrated in germ and bran portions of the cereal grain and are less concentrated in larger endosperm portion. The modern cereal milling methods have the capacity to substantially remove the germ and bran portions from the endosperm portion. The bran and germ portions thus separated in the milling operation are considered by-products of the milling operation and are not currently used in significant amounts in human food compositions.

The milling process used to remove the bran and germ portion of the grain may differ from one cereal grain to another cereal grain. However, the current milling process for each cereal grain has the ability to separate the bran and germ fractions in substantial quantity from the rest of the endosperm. The bran and germ material obtained from any one of the current milling process can be stabilized by the mechanical extrusion process of the this invention.

For example, wheat is conventionally milled in roller mills resulting in the separation of outer bran layer and germ from the endosperm portion. A typical roller mill will include a sequence of counter-rotating opposed rollers, which progressively break the wheat into smaller and smaller sizes. The output from each pair of rollers is sorted into multiple streams, typically by means of sifters and purifiers, to separate the bran and germ from the endosperm, and to direct coarser and finer fractions of the endosperm to appropriate rollers.

In general, during the processing of wheat, two different streams of products namely, the flour stream and the bran/germ stream, are produced. The flour stream contains mainly white flour derived from endosperm while the bran/germ stream may contain a certain amount of endosperm material. During subsequent cycles, the bran/germ portion is enriched in bran/germ components and the amount of endosperm component is substantially reduced. The bran/germ portion may be separated into sub-categories generally referred to as “midds,” “shorts,” “germ,” “red dog,” and “bran.” Sometimes the bran stream is sub-categorized as fine and coarse bran fractions. This is in contrast to the rice milling industry where only one type of bran/germ material is produced. Using the inventive process, any one stream of bran/germ or any combination of different stream portions from the milling of grains can be stabilized.

In the case of the rice, after the removal of the hull (the outer rough coating of the rice grain), the bran layer is polished off. Machines typically used for removing bran/germ fractions generally incorporate abrasive action, wherein the rice grains are subjected to the positive actions of abrasive surfaced rollers, such that the rice grains are rubbed on metal surfaces and each other. U.S. Pat. No. 4,426,921 describes a method and apparatus for removing bran/germ fraction from dehulled rice grains. The resulting polished endosperm is consumed as white rice and the bran/germ layer removed in this process is currently discarded as a by-product or sometimes used as animal feed. Stabilization of the bran/germ portion resulting from rice milling operation would make it suitable for human consumption and for greater use in animal feed.

In corn, the bran is derived from pericarp located beneath the water impermeable cuticle. Because of its high fiber content, the pericarp is tough. In the corn milling operation, the corn is tempered by the addition of water and passed through a corn degerminator, which frees the bran and germ and breaks the endosperm into two or more pieces. The stock from degerminator is dried and passed through a separator and through a centrifugal-type aspirator to remove “aspirator bran.” The aspirator bran may contain some or all of the germ fraction.

The term “bran” generally refers to the thin layer surrounding the endosperm in a cereal grain. In general, the bran fraction removed in the cereal milling operation contains some or all of the germ fraction of the cereal grain. As used in this invention, the terms “bran” or “bran fraction” includes some or all of the germ fraction. This mixed bran and germ fraction is also referred as “bran/germ” fraction.

The shelf-life of the bran/germ fraction resulting from a cereal milling operation can be extended by subjecting it to the stabilization process of the current invention. Ideally, the mechanical extruder of the present invention can be directly linked to the bran/germ stream exiting the cereal milling operation. Such direct linkage of the bran/germ production stream to the mechanical extruder would minimize the length of time between milling and stabilization of the bran/germ fraction leading to the production of a nutritionally-enriched bran/germ fraction with several desirable features.

Stabilization as used in this invention means the treatment of a plant material to inhibit degradation of the oil present in bran/germ fraction. In its chemical composition, the oil present in the bran/germ material is an ester made up of glycerol and fatty acids. During standard milling operations, the hydrolytic lipase enzymes present in the bran/germ material are brought into contact with the oil substrate. The lipases cause the degradation of plant oil leading to the formation of free fatty acids (FFA). The formation of FFA through this enzyme action leads to the development of hydrolytic rancidity.

In addition to this hydrolytic rancidity, it is also necessary to address the oxidative rancidity developed during the cereal milling operation. The cereal bran/germ materials in general contain certain anti-oxidative compounds such as tocopherols and tocotrienols. These anti-oxidative compounds help to protect the oil present in the bran material against oxidative damage. If these anti-oxidative compounds are lost during or after the milling operation, there is a greater likelihood of oxidative damage to the oil leading to the development of oxidative rancidity. Just as the case with the hydrolytic rancidity, oxidative rancidity can also lead to the accumulation of FFA in the bran material during the milling process and subsequent storage.

Measurement of FFA content in the bran material after stabilization and comparing that value to the FFA content in the raw bran material, is a good measure of the stabilization index. Alternatively, the measurement of absolute content of the FFA can also be used to determine the relative efficiency of the stabilization procedure. FFA content is expressed as the percentage of FAA in the oil fraction of the bran material. A FFA content of 5% by weight or lower is desirable. Therefore a bran/germ material resulting from a stabilization process, such as that of the present invention, should maintain a FFA content of 5% or lower during the course of storage for at least 12 months. The free fatty acid content of the bran/germ material can be measured either before stabilization, immediately after stabilization or periodically during long-term storage using one of the well known analytic methods for free fatty acid quantification.

The bran/germ fraction resulting from the mechanical extrusion process of the present invention has low lipolytic/oxidative enzyme activity as well as low microbial and insect larval loads. The inactivation of lipolytic and oxidative enzymes as well as a significant reduction in the microbial load contribute to increased shelf-life for the bran/germ product.

In one embodiment, the extrusion method of the invention produces a stabilized composition that has a shelf-life of at least 12 months or more. As used herein, the “shelf-life” may refer to the length of time during which the FFA content of the extruded composition remains below about 5%, more preferably below about 4%, and most preferably below about 2.5% of the total fatty acid (FA) content in the extruded composition. Alternatively, the shelf-life may also be described in terms of a reduced microbial load wherein the total plate count (TPC) for microbial load is preferably at a maximum of 10,000 colony forming units (cfu)/gram of the stabilized bran/germ fraction. The total count for Coliform bacteria in the stabilized bran/germ fraction should be no more than 100 cfu/gram of the stabilized bran/germ fraction. The number of Escherichia coli bacterium in the stabilized bran/germ fraction should be less than 10 cfu per gram of stabilized material. The stabilized bran/germ fraction should be free of Salmonella bacterium. The stabilized bran/germ should have yeast and mold count of 100 cfu/gram of stabilized bran/germ fraction or less.

Hydrolytic rancidity is caused by the interaction of the lipases with the oil fraction during the milling process. Oxidative rancidity is caused by the exposure to certain oxidases such as peroxidase in the presence of oxygen and to the loss of antioxidants in the bran/germ fraction. The activity of the lipases and peroxidases can be measured using methods well known in the art. In addition to measuring the FFA content of the bran material before and after the stabilization process, the activities of lipase and peroxdase enzymes can also be used as an index for measuring the efficiency of the stabilization process. The stabilization process should inactivate these enzymes, contributing to the long-term stability of the end product.

Yet another method for determining the efficiency of stabilization process involves the measurement of anti-oxidative compounds in the bran/germ fraction before and after the stabilization process. Other methods utilizing extrusion stabilization can destroy important nutrients present in the stabilized extruded composition including the anti-oxidants. For example, in rice bran, dry extrusion methods can destroy some of the naturally occurring antioxidants. The inventive mechanical extrusion process described herein produces a stabilized extruded product that retains high levels of desirable nutrients including anti-oxidants.

Examples of desirable nutrients include tocopherol and tocotrienol derivatives, which are well known fat-soluble antioxidants present in the raw bran/germ materials. These anti-oxidative compounds are believed to play an important role in protecting cells from free radical damage and possibly in the prevention of certain diseases including cardiac disease, cancer, cataracts, retinopathy, Alzheimer's disease, and other neurodegenerative disorders, and may have beneficial effects on the symptoms of arthritis, and as anti-aging components.

In addition, tocopherol compounds have Vitamin E activity. Vitamin E is used commonly in chicken feed for improving the shelf-life, appearance, flavor, and oxidative stability of meat, and to transfer tocols from feed to eggs. Vitamin E has been shown to be essential for normal reproduction. Vitamin E also improves overall performance, and enhances immuno-competence in livestock animals. Vitamin E supplements in animal feed impart oxidative stability to milk products. The demand for natural tocopherols as supplements has been steadily growing.

Both the tocopherols and tocotrienols occur in alpha, beta, gamma and delta forms, determined by the number of methyl groups on the chromanol ring. Each form has slightly different biological activity. In 1995, the worldwide market for raw refined tocopherol was $1020 million; synthetic materials comprised 85-88% of the market, the remaining 12-15% being natural material. The best natural sources of tocopherols and tocotrienols are vegetable oils and grain products. Currently, most of the natural Vitamin E is produced from gamma-tocopherols derived from oil processing, which is subsequently converted to alpha-tocopherol by chemical modification. Alpha-tocopherol exhibits the greatest biological activity.

Various forms of tocopherols and tocotrienols in the bran/germ materials can be quantified both before and after stabilization using well-known analytical techniques. These antioxidative compounds can also be quantified in the bran/germ materials during long term storage after stabilization. The amount of various tocopherol and tocotrienol compounds present in the bran/germ fraction before stabilization, immediately after stabilization and during long-term storage after stabilization can be used as an index for determining the efficiency of the stabilization procedure. For example, in the case of raw rice bran, the tocopherol and tocotrienol contents are reported to be 12 mg/100 grams and 13.6 mg/100 grams respectively.

The stabilized bran of the present invention shows a high level of tocopherol and tocotrienol compounds. Because the bran material is currently disposed of as by-product or used as a animal feed, stabilized bran material represents a potentially inexpensive source for commercial production of tocopherol and tocotrienol compounds, which can be used in both in the human food compositions and in the animal feed industry.

In one embodiment of the present invention, the method for deactivating the degradative enzymes involves the use of a mechanical extruder. Mechanical extruders are well known in the art, and are typically used for extruding oil seeds. Heat and pressure generated during the passage of the bran material through the extruder stabilizes the bran material. Optionally, water can be added to the bran material being extruded to assure good thermal conduction. The degree of expansion of the product upon extrusion depends on a number of factors such as temperature, pressure and moisture content.

In accordance with the invention, stabilization of the oil in plant material is carried out by a mechanical extrusion process immediately after the primary milling. The process parameters are controlled to a such an extent to inhibit the development of both hydrolytic rancidity and oxidative rancidity. For example, either by controlling the retention time of the bran material within the extruder barrel or by controlling the temperature of the bran material, it is possible to inactivate the enzymes responsible for the development of both oxidative and hydrolytic rancidity.

During the passage of the bran material through the barrel of the extruder, the bran material is subjected to heating. The heating process causes the denaturation of the degradative enzymes, such as lipase, lipoxygenase and peroxidase, and thereby induces the long term stability to the bran material. The heating process also helps in reducing the microbial load in the bran sample. The exposure of the bran material to appropriate temperature causes the killing of bacteria and the insect larvae in the bran material.

The expansion as well as the heating process within the barrel depend on factors such as temperature, moisture, pressure and residence time of the bran material within the barrel. A rapid, even generation of heat between the bran/germ mass and the metal surface helps to assure denaturation of the degradative enzymes. Such an even generation of temperature gradient across the bran/germ mass and the metal surface can be achieved through appropriate modifications in the temperature of the bran material while inside the extruder, moisture content of the bran material, pressure inside the extruder, and the residence time of the bran material. Applicable temperature ranges for stabilizing bran/germ fraction may range from about 100° F. (38° C.) to about 350° F. (176° C.), more preferably from about 230° F. (110° C.) to about 320° F. (160° C.) and most preferably from about 250° F. (121° C.) to about 300° F. (149° C.). The temperature can be monitored either using a thermocouple or by using a resistance thermal device.

The extrusion rate is controlled to create a back pressure that raises the temperature of the bran mass to a level sufficient to inactivate the target degradative enzymes. The pressure inside the extruder can be controlled by the feed rate of the bran material into the extruder as well as by manipulating moisture content of the bran material and the residence time of the bran material in the barrel. The suitable moisture content (w/w) of the bran/germ material may range from about 3 to about 26%, preferably from about 4 to about 15% and most preferably from about 10 to about 13%. Appropriate moisture content of the bran material facilitates the efficient heat conduction. The moisture content of the bran/germ fraction can be manipulated by the addition of water. Water may be added at the rate of about 4 liters to about 400 liters per hour and more preferably from about 40 to about 200 liters per hour. However, the rate of water addition to achieve appropriate moisture content depends on the rate of addition of the bran material. For example, when the bran material is fed into the extruder at the rate of 1000 kg per hour, to increase the moisture content of from the initial value of 5% (w/w) to 10% (w/w), water should be added at a rate of about 50 liters per hour.

The pressure and temperature parameters inside the extruder are directly proportional to the input power requirement for the extruder. The power required to run the extruder can be measured directly by a meter connected to the drive motor of the extruder. The power to the drive motor can be supplied either from an electrical source or from a diesel power generator. In addition to the temperature and pressure parameters, the power requirement for the extruder also depends on the feed rate of the bran material to be stabilized. The power requirement of the extruder for stabilization of the bran/germ fraction is expressed as kW-hr/kg bran. The energy consumption of the extruder may range from about 0.04 to about 0.15 kW-hr/kg, more preferably from about 0.06 to about 0.12 kW-hr/kg, and most preferably from about 0.07 to about 0.09 kW-hr/kg.

The initial test for the stabilization of bran material is the test to determine the inactivation of lipase enzyme in the bran/germ fraction. The long term stability of the bran/germ fraction is determined by measuring the FFA content. Stabilization of the bran/germ fraction is a function of the residence time in addition to other factors such as temperature, pressure and moisture content. The term “residence time” refers to the length of time the bran material stays within the barrel of the extruder. The suitable residence time for stabilizing the bran/germ fraction may range from about 1 second to about 4 minutes, and more preferably from about 5 seconds to about 2 minutes.

By manipulating the power requirement, moisture content, and the residence time, it is possible to identify appropriate stabilization conditions for each type of bran materials. The temperature, pressure, moisture and residence time parameters of the extruder suitable for use with the bran fraction from one particular cereal grain may not be appropriate for the second type of bran material derived from a second type of cereal grain. For example, the rice bran and raw wheat bran have different physical consistencies. As a result, the mechanical extruder specifications for stabilization of rice bran may not be appropriate for achieving the stabilization of raw wheat bran. However, by means of altering the extruder parameters appropriately, it is possible to stabilize any type of bran material.

The mechanical extruder suitable for use in the present invention may either be a single screw extruder or a twin screw extruder. The single screw extruder as well as the double screw extruder may be in a single flight configuration or in a double flight configuration. An extruder with a single flight configuration has a single ribbon or flighting wrapped around the rotor at a consistent spacing. This results in one discharge into the next section per revolution. Double flight configuration has two ribbons of flighting wrapped around the rotor 180 degree apart, resulting in two discharges per revolution and smooth material flow.

While stabilization requires a relatively high temperature and an appropriate residence time for the bran/germ material in the barrel, it is also desirable to make sure that the nutritional value of the bran/germ material is not compromised while achieving the stabilization and reducing the microbial load using the mechanical extrusion procedure. Similarly, it is necessary to make sure that the quality and the quantity of the micronutrients in the bran materials are not compromised during the mechanical extrusion procedure.

Using the stabilized bran material of the present invention, it is possible to create a whole grain flour composition using an appropriate portion of stabilized bran fraction with an appropriate portion of a flour fraction derived from the endosperm part of the original cereal grain.

For example, mixing the stabilized wheat bran with white wheat flour results in a composition similar to whole wheat flour—a reconstituted whole grain flour. In the whole wheat flour, the proportion of the natural constituents such as endosperm, germ, and bran remain unaltered other than the moisture content. In the reconstituted whole grain flour (white wheat flour reconstituted with stabilized bran portion), the proportion of the endosperm and bran portions are very similar to the proportion of these two components in the whole wheat flour obtained by grinding the entire wheat kernel without first separating the endosperm portion from the bran and germ portions. The only difference between whole grain flour reconstituted with stabilized wheat bran and whole grain wheat flour obtained from grinding the whole wheat grains, is that the reconstituted whole grain flour is more stable without showing any signs of rancidity with increasing time.

In another embodiment, the present invention provides for a blend composition comprising wheat bran/germ fraction stabilized using the mechanical extrusion process of present invention, and wheat flour, wherein the composition comprises between about 1 to about 51 wt % stabilized wheat bran/germ fraction. Since the present extrusion stabilization process heats or “cooks” the wheat bran/germ fraction, the resulting stabilized fraction is easily digestible. Bioavailability of specific nutrients such as phosphorus have been documented in the cooked bran fractions (Belyea J. L. et al. 1992, J. Appl. Poultry Res. 1:315-320). Therefore, combining wheat flour with stabilized wheat bran/germ fraction may enhance the nutritional value of the resulting blend composition.

The bran/germ fraction of a particular cereal grain stabilized by using the mechanical extrusion process of the present invention can also be combined with the flour fraction from other cereal grain, legumes, or stabilized bran/germ fraction from other cereal grains. For example the stabilized bran/germ fraction from wheat can be combined with the stabilized bran/germ fraction from oat. Wheat bran fraction is rich in insoluble fibers while the oat bran fraction is rich in soluble fibers. A combination blend of stabilized oat and wheat bran provides an ideal mix of the soluble and insoluble fibers. In another embodiment, the stabilized bran/germ fraction from a cereal grain can be combined with the flour fraction derived from a legume. The flour fraction can be derived from legumes such as garbanzo, soy, lentils or black eyed beans. In yet another method, the stabilized bran/germ fraction from a cereal grain may be combined with product resulting from the mechanical extrusion of oil seed. Those skilled in the art will know of the other materials that can be combined with stabilized bran/germ fraction of a cereal grain to yield a nutritionally enriched food products.

In certain instances, it may be desirable to bleach some components such as wheat bran/germ fraction while applying the stabilization processing. This may be accomplished through, for example, the addition of a bleaching agent such as hydrogen peroxide, benzoyl peroxide and similarly functional food grade bleaching agents, as is commonly known in the art. An alternative approach to altering the color of the food component would be through the use of food grade titanium dioxide blended into the wheat bran/germ during the stabilization process.

In the following examples, rice and wheat bran fractions were subjected to stabilization process as illustrative examples. Modifications and changes to the procedures are within the purview of a skilled artisan to apply the teachings of this invention to stabilization of bran materials obtained form other cereal grains as well as the bran material obtained from oil seed. The present extrusion stabilization method is useful for other bran/germ fractions, such as for example, corn, oats, rye, barley, sorghum, triticale, millet, buckwheat, fonio, quinoa, teff, and kaniwa for decreasing pest infestation, and microbial load and increasing the shelf-stability of these cereals and millets. The present extrusion stabilization process can also be used to stabilize the bran fractions from oilseeds. Such oilseeds include, for example, sunflower, safflower, sesame, mustard, rapeseed, peanut, flax seed, soybean and the like.

### Example 1

### Monitoring the FFA Content in the Raw Rice Bran/Germ Fraction and in the Stabilized Rice Bran/Germ Fraction

The rice bran/germ fraction was stabilized using a mechanical extruder having a 125 hp/1100 rpm drive motor, and the following parameters: the bran/germ fraction was fed into the extruder at 1500 kg/hr, at a stabilization temperatures of about 141° C. and water added at a rate of 27 to 54 liters/hr.

In the determination of the FFA content in the oil derived from raw rice bran and in the stabilized rice bran/germ fraction, American Oil Chemists Society's (AOCS) Official Method Ca 5a-40 was followed. Stabilized bran samples were adjusted to 11% moisture content (similar to raw rice bran) prior to lipid extraction. Oil was extracted from 10 gram sample with hexane in a Soxhlet extractor for at least 6 hours and recovered in a total volume of 100 ml. FFA content was determined by removing the solvent from 10 ml of extract, dispersing the oil residue in 75 ml of isopropyl alcohol followed by 75 ml of 0.04% phenolphthalein in 95% ethanol (neutralized with 0.2N KOH to a faint pink color), and titrating duplicate or triplicate 50-ml volumes with standard 0.016N KOH, shaking vigorously until the appearance of the first permanent pink color of the same intensity as that of the neutralized alcohol before the addition of the FFA samples. The color must persist for 30 seconds. A blank consists of 50 ml of a 1:1 mixture of isopropyl alcohol and neutralized 0.04% phenolphthalein in 95% ethanol was also titrated. FFA content was calculated as oleic acid and expressed as weight percent of the total oil. The total oil content was measured gravimetrically after desolventizing 50 ml of the hexane extract and drying the residual oil at 110° C. for 15 min. The percentage of oil in the bran was expressed on a dry weight basis.

The long term stability of bran/germ fraction obtained from the stabilization procedure was tested by storing duplicate 1 kg processed samples in clean cotton bags at 32° C. and 85% relative humidity for a period of 24 months. The samples were analyzed for FFA content on monthly intervals throughout the storage period.

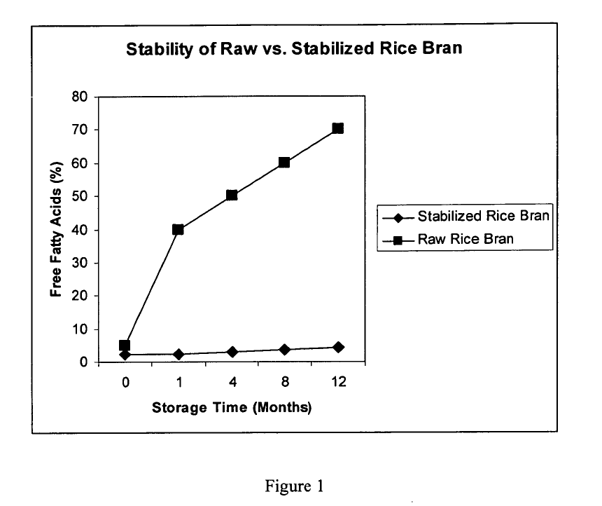

FIG. 1 illustrates changes in the FFA content in the oil extracted from raw rice bran/germ fraction as compared to the FFA content in the bran/germ fraction stabilized by the mechanical extrusion process of the present invention. For comparison purpose, the FFA content of the raw rice bran fraction used in the FIG. 1 was obtained from an earlier scientific publication (Shin et al. 1997, J. Food. Sci. 62: 704-728). The development of FAA percent in the raw rice bran/germ fraction over a 12-month period increased significantly from the initial value of 5% to 70%. During the same time period, the stabilized rice bran/germ fraction showed only a minimal change in FAA content from 2.3% to 4.2%.

The FFA level in the stabilized rice bran was monitored on a monthly basis for a period of 2 years. The level of FAA for a period of first twelve months stayed below 4% level. Even after 23 months after stabilization, the FAA level was below 5%.

Organoleptic evaluation is the standard for the detection of rancidity. The stabilized rice bran/germ fraction did not show any off flavor or notes when subjected to sensory evaluation (internal sensory evaluation) after 12 months storage at ambient temperature. Thus the extrusion stabilization process not only keeps the free fatty acids levels below 5%, but also reduces or eliminates off flavors as judged through sensory evaluation.

The stabilized rice bran produced by the present extrusion stabilization method has the longest shelf-life of at least one year compared to about 90-day shelf-life of the rice bran fractions stabilized by alternative methods known in the art.

### Example 2

### Microbial Load in the Stabilized Rice Bran/Germ Fraction

The microbial load in the stabilized bran/germ fraction was determined using the Association of Analytical Communities (AAOC) Method 990.12 (Aerobic plate count in food) and Method 997.02 (Yeast and mold count in food). The total plate count (TPC) in the stabilized rice bran/germ fraction was found to be under 10,000 cfu/gram of stabilized bran/germ fraction. The total number of coliform bacteria per gram of stabilized of bran/germ material was less than 100. Similarly, as shown in the Table 1, the frequency of E. coli, Salmonella, yeast and mold were all significantly very low in the stabilized bran/germ fraction.

Rice bran stabilized by the mechanical extrusion process of the present invention has one of the lowest microbial loads in the cereal industry. This low load is critical for stabilizing bran and germ components because these components have a high propensity for degradation and infestation due to their relatively high oil content. The low microbial load resulting from the extrusion-stabilization process prevents the degradation of fat and also keeps FFA production low, thereby preventing the development of rancidity. Results of a microbial analysis done with stabilized rice bran/germ fraction is shown in Table 1.

TABLE 1
Microbiological specification for Stabilized Bran Component

| Microorganism | Count | |
|---|---|---|
| TPC | <10,000 | CFU/g |
| Total Coliform | <100 | CFU |
| E. Coli | <10 | CFU/g |
| Salmonella | Negative | |
| Yeast | Max: 100 | CFU/g |
| Mold | Max: 100 | CFU/g |

### Example 3

### Determination of Anti-Oxidative Content in the Stabilized Rice Bran/Germ Fraction

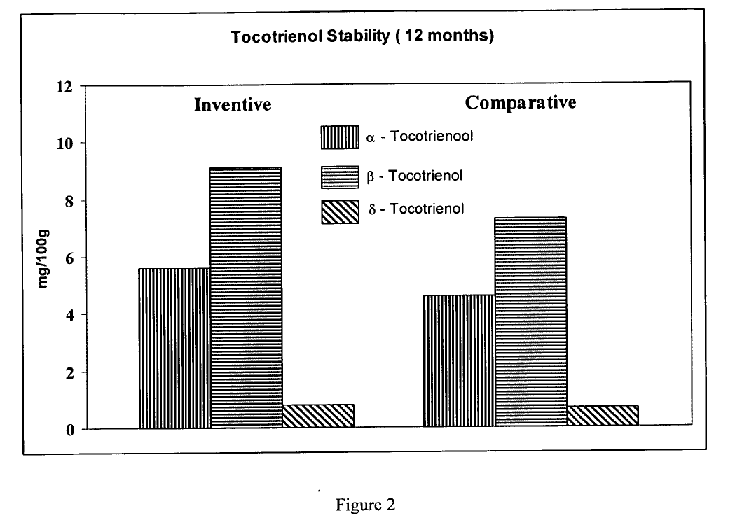

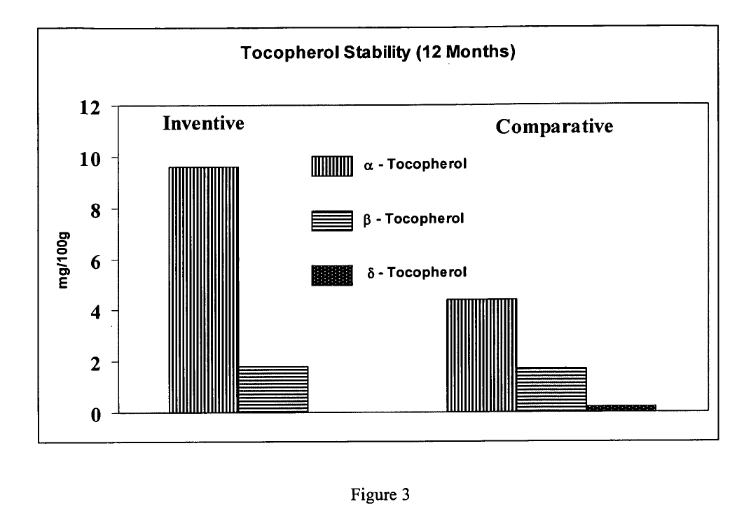

The amounts of various types of tocopherols and tocotrienols present in the stabilized bran as compared to the amounts present in the raw rice bran were determined using the Official method Ce 8-89 of American Oil Chemists Society (AOCS). High temperatures and pressures, which can be utilized in many extrusion processes, can destroy the vitamin and nutrient value of an extruded product. In order to demonstrate that the present mechanical extrusion stabilization process does not destroy the anti-oxidants present in the rice bran/germ fraction during the stabilization process, the quantity of the various forms of tocotrienol and tocopherol compounds present in the stabilized rice/germ fraction were determined, and compared with the amounts present in the fresh raw rice bran/germ fraction. The results shown in FIGS. 2 and 3 indicate the stabilize rice bran did not show any decrease in the amount of any of the tocopherol (α, β, and δ tocopherols) and tocotrienol (α, β, and δ tocotrienol) compounds tested. In fact, the stabilized rice bran/germ fraction showed a slight increase in the amounts of tocotrienol and tocopherol compounds when compared to the amount present in the raw rice bran/germ fraction. This apparent increase in the tocopherol and tocotrienol content in the stabilized bran may be the result of moisture in the stabilized rice bran/germ fraction.

### Example 4

### Stabilization of the Raw Wheat Bran Using Mechanical Extrusion Process

In this experiment, the raw wheat bran was stabilized using a mechanical extruder at different temperatures in the range of 195° F. to 330° F. (91° C.-166° C.) to determine the ideal temperature range for inactivating the hydrolytic and oxidative enzymes associated with wheat bran/germ fraction.

The lipase enzyme was assayed using sensitive colorimetric assays, such as the Oat-Chek I lipase assay kit. The peroxidase assay was carried out using the Oat-Chek II peroxidase assay kit. Both kits are LSB products available from Alteca Ltd. (http://www.alteca.com).

The lipase and peroxidase enzymes were measured in all the test samples immediately after mechanical extrusion as well as in a raw wheat bran, as a control (Table 2). The raw wheat bran showed very high activities both for peroxidase and lipase. In the test samples the peroxidase enzyme was inactivated at temperatures higher than 215° F. (102° C.) and the lipase activity was inactivated at temperatures higher than 236° F. ((113° C.).

TABLE 2
Effect of Stabilization of wheat bran on the activities of
lipase and peroxidase enzyme levels

Enzyme activity

| Temperature | Lipase | Peroxidase |
|---|---|---|
| Raw bran | Very High | Very High |
| 195° F. (91° C.) | Positive | Positive |
| 215° F. (102° C.) | Positive | Negative |
| 223° F. (106° C.) | Positive | Negative |
| 236° F. (113° C.) | Negative | Negative |
| 261° F. (127° C.) | Negative | Negative |
| 270° F. (132° C.) | Negative | Negative |
| 272° F. (133° C.) | Negative | Negative |
| 290° F. (143° C.) | Negative | Negative |
| 300° F. (149° C.) | Negative | Negative |
| 305° F. (152° C.) | Negative | Negative |
| 317° F. (158° C.) | Negative | Negative |
| 330° F. (166° C.) | Negative | Negative |

All publications and patent applications cited in this specification are herein incorporated by reference. Although the foregoing invention has been described in some detail by way of illustration and example for purposes of clarity of understanding, it will be readily apparent to those of ordinary skill in the art in light of the teachings of this invention that certain changes and modifications may be made thereto without departing from the spirit or scope of the appended claims

What is claimed is:

1. A method of stabilizing a plant bran material to a shelf-life of at least 12 months, the method comprising the steps of:
loading the raw bran material into a mechanical extruder;
applying power, heat and pressure at suitable levels for enzyme denaturation;
maintaining the bran material in the extruder at a residence time suitable for stabilization;
adding water to maintain a level of moisture content in a stabilized bran material; and,
testing free fatty acid levels in the stabilized bran material.

2. The method of claim 1, wherein the bran material is added to the extruder at a rate of about 20 kg/hr to about 1500 kg/hr.

3. The method of claim 1, wherein, the bran material is fed into the extruder at a rate of about 200 kg/hr to about 1200 kg/hr.

4. The method of claim 1, wherein the power requirement is in the range of about 0.04 kW-hr/kg to about 0.15 kW-hr/kg.

5. The method of claim 1, wherein the temperature of the mechanical extruder is in the range of about 38° C. to about 176° C.

6. The method of claim 1, wherein the temperature of the mechanical extruder is about 121° C. to about 149° C.

7. The method of claim 1, wherein the residence time may range from about 1 second to about 4 minutes.

8. The method of claim 1, wherein the residence time may range from about 5 seconds to about 2 minutes.

9. The method of claim 1, wherein the water addition to the bran material is at a rate of about 4 liters/hr to about 400 liters/hr.

10. The method of claim 1, wherein the water addition to the bran material is at a rate of about 40 liters/hr to about 200 liters/hr.

11. The method claim 1, wherein the bran material is from a cereal grain.

12. The method of claim 1, wherein the bran material is from wheat.

13. The method of claim 1, wherein the bran material is from rice.

14. The method of claim 1, wherein the bran material is from an oil seed.

15. The method of claim 1, wherein the stabilized bran has a free fatty acid content of 5% or lower.

16. The method of claim 1, wherein the stabilized bran has no detectable lipase and peroxidase activities.

17. The method of claim 1, wherein the stabilized bran has an anti-oxidant component content similar to that of a raw bran.

18. An extruded grain composition comprising a stabilized bran fraction and at least one other flour component, the stabilized bran fraction having a shelf-life of at least 12 months.

19. The composition of claim 18, wherein the stabilized bran portion has a free fatty acid content of 5% or lower.

20. The composition of claim 18, wherein the stabilized bran fraction has no detectable lipase or peroxidase activity.

21. The composition of claim 18, wherein the stabilized bran has a microbial load of less than 10,000 colony forming units per gram of the stabilized bran.

22. The composition of claim 18, wherein the stabilized bran has the tocopherol content and tocotrienol content similar to that of raw bran.

23. A method for manufacturing a stabilized whole grain product stable for at least 12 months, the method comprising the steps of:
milling the cereal grain to produce a flour stream and a bran stream;
loading the bran stream into a mechanical extruder;
inactivating the lipase and peroxidase enzymes associated with bran fraction by means of suitable heat, pressure and residence time in the mechanical extruder; and,
combining the bran fraction with the flour stream to produce a composition having a ratio of bran and endosperm components in the same ratio as an original cereal grain.
